(19) United States
(12) Patent Application Publication
(10) Pub. No.: US 2008/0094496 A1
(43) Pub. Date: Apr. 24, 2008

(54) MOBILE COMMUNICATION TERMINAL

(76) Inventors: Kong Qiao Wang, Beijing (CN); Hao Wang, Beijing (CN); Ying Fei Liu, Beijing (CN)

Correspondence Address: PERMAN & GREEN, 425 POST ROAD, FAIRFIELD, CT, 06824, US

(21) Appl. No.: 11/552,348

(22) Filed: Oct. 24, 2006

(51) Int. Cl. H04N 5/225; G06K 9/22; H04N 5/222; H04N 9/04

(52) U.S. Cl. 348/333.1; 382/313; 348/207.99

(57) ABSTRACT

A camera equipped mobile communication terminal is used in an image recording mode during which a camera view is displayed. A guiding pattern is displayed in a viewfinder mode such that it facilitates for a user to adjust the camera view. Detection is made that the camera view is in a static state and recording of an image of the camera view is performed. Extraction of a sub-image including an array of picture elements from the recorded image, at a position within the recorded image that corresponds with the guiding pattern being displayed, is then performed and an optical character recognition process is made on the extracted sub-image. This OCR process yields a sequence of symbols that are displayed.

### TECHNICAL FIELD

The disclosed embodiments relate to a mobile communication terminal and a method of controlling a mobile communication terminal in connection with recognition of text in a recorded image.

### BACKGROUND

Communication devices have during the last decades evolved from being more or less primitive telephones, capable of conveying only narrow band analog signals such as voice conversations, into the multimedia mobile devices of today capable of conveying large amounts of data representing any kind of media. For example, a telephone in a GSM, GPRS, EDGE, UMTS or CDMA2000 type of system is capable of recording, conveying and displaying both still images and moving images, i.e. video streams, in addition to audio data such as speech or music.

Furthermore, internationalization is driving people to actively or passively use multiple languages in their daily lives. Thus language translation, or simply looking up in a dictionary, is a common but important procedure in many situations. For example, people often encounter new and unknown words when they read newspapers or magazines in a foreign language, or people do not know what the corresponding word is in a foreign language to the word in their native language.

Optical character recognition (OCR) based applications integrated in camera equipped mobile phones have, consequently, emerged during recent years. Such applications typically involve taking a snapshot of a piece of text and providing the digital image to a recognition engine running in the terminal or in a server connected to the terminal via a communication network.

A problem with current OCR enabled terminals is how to enable a user to easily identify or point out a targeted word or phrase that is to be translated by the recognition engine. Typically, solutions in prior art involve the user having to perform more or less complex interactions with a user interface including various selection actions and triggering actions to actually record the image of the targeted word or phrase. Needless to say, this is not user friendly and often deter users from using the recognition capabilities of the terminal.

### SUMMARY

It would be advantageous to overcome drawbacks relating to prior art communication terminals as discussed above.

The disclosed embodiments include a method, a communication terminal and a computer program according to the appended claims.

Hence, according to a first aspect of the disclosed embodiments, a mobile communication terminal is controlled, while the terminal is in an image recording mode during which a camera view is displayed, by way of displaying a guiding pattern configured such that it facilitates for a user to adjust the camera view, detecting that the camera view is in a static state, recording an image of the camera view in the detected static state, extracting a sub-image comprising an array of picture elements from the recorded image, said sub-image being at a position within the recorded image that corresponds with the guiding pattern being displayed, performing an optical character recognition process on the extracted sub-image, yielding a sequence of symbols, and displaying the recognized sequence of symbols.

The detection that the camera view is in a static state may comprise detection of spatial changes and detection of absence of spatial changes in the camera view during a specific time interval.

Furthermore, the detection may comprise processing of an algorithm representing a hand-held shaking model. In this respect, prior to the recording an image of the camera view in the detected static state, the hand-held shaking model may be determined by way of a training sequence involving detections of spatial changes and detection of absences of spatial changes in the camera view during specific time intervals.

The method may further comprise, prior to the recording of an image of the camera view zooming the camera view such that the extraction of the sub-image results in an extracted sub-image having a predetermined spatial scale.

Moreover, the image recording mode may be such that, during the displaying of the camera view, a first spatial image scale is used and, during the recording of an image of the camera view in the detected static state, a second spatial image scale is used.

In other words, an intuitive “non-click” user interface solution is presented for mining, i.e. pointing out and recording a targeted word or phrase, target words to be recognized.

One principle of this “non-click” solution is based on the realization that, typically in prior art solutions, when snapshot pictures are created by user actions such as pressing a key or similar on the terminal, the hand shaking that typically occurs may damage the results of the ensuing OCR process. Moreover, the typical pause occurring during image taking is not convenient for word or phrase mining in many applications.

According to one aspect of the disclosed embodiment, this problem is mitigated in that camera movement information is utilized in performing the mining operation.

During the displaying of the camera view, i.e. during a “viewfinder” process, a cursor is displayed in a certain position of the displayed view that the camera sees, e.g. in the central area of the display. The camera view is then moved, typically by the hand of a user, to allow the cursor point to a target word/phrase, which is present on e.g. a piece of newspaper, magazine, menu etc. The camera is then held steady in a more or less static way during a short time period, typically several hundred micro seconds. This brief pause is then detected and a decision is made based on previous movement states whether to start the processing involving recording of the current view, extraction of a sub-image at the target, recognition of the recorded image data and any other subsequent processing such as displaying and translation of the recognized word or phrase.

An advantage of such a method is that it makes the feel of use smooth and it provides efficiency in terms of performing word mining because there is no explicit operation of pointing at the target with special means such as a stylus or operate a joystick to point out the target word or phrase. The brief pause of the view on the target is a very natural behavior from the point of view of the user, since users typically stop for a while when they find the target word in the viewfinder in order to see it more clearly.

From a designer point of view, because during the displaying of the camera view (i.e. during the “viewfinder” process), a detected image frame typically has a smaller size than that of a recorded image frame, the movement detection can be done very quickly and will not be noticeable by the user of the terminal. The subsequent processing, i.e. extraction, OCR, word association and possible post processing such as translation, may take longer time. However, such processing is started only when a target is aimed at (i.e. when a brief pause is detected in the static state) and the processing can be executed during this brief pause. Hence, the user will not experience any inconvenient delays.

By using a hand-held shaking model the robustness can be improved by avoiding the false-detection of static state if there is very small but inevitable hand shaking while aiming at the target.

Furthermore, the method may further comprise processing the recognized sequence of symbols, involving a translation process comprising accessing at least a first data base of words. The translation process may include at least one step of a three-step procedure of accurate translation, fuzzy translation and word-by-word translation.

In such cases, a first database may comprise words representing compound items and a second database may comprise words representing ingredients of compound items in the first database. An example of a translation process is one that involves translation of restaurant menu words.

In other words, one example of such an application is recognizing restaurant menu items. This is an excellent self-assistant feature of mobile devices for foreign travelers. The application can tell the travelers what dishes they are selecting just by recording a snapshot of the menu items and obtaining an immediate translation on the display of the terminal.

Of course, the invention is applicable in many other fields than in a restaurant menu application, such as translation of medicine terms, company name and company address translation. For example, main ingredients of medicines can be listed for understanding a kind of medicine in case of emergency and a database of the main districts and streets of a city can be constructed and used for locating a company.

Advantages of such an application include, because the introduction of fuzzy translating compensates the limitation of camera OCR accuracy and the ingredient information provides more comprehensive translation, an improved way of dealing with an ever changing and more or less impossible inclusive menu items database.

Another advantage can be seen by noting that the structure of multi-database-multi-category-translation provides a universal solution for data mining and translating from an open and inflated data source. Even if no exact matching record is found from the translation database, an assistant database that can give indications and background knowledge of the target item (words, phrase to be translated) is very helpful for the user.

Furthermore, it is also advantageous that the invention may be realized in the form of an “intelligent user interface”. Users need not pay attention to the implementation details and will perceive no technical issues that might be confused, and they will typically only feel the easy operation and friendly output information.

In other aspects, the invention provides a terminal and a computer program, the functionality and advantages of which correspond to the method as discussed above.

### BRIEF DESCRIPTION OF THE DRAWINGS

FIG. 1 schematically illustrates a functional block diagram of a mobile communication terminal according to an embodiment.

FIG. 2a is a flowchart of a method according one embodiment.

FIG. 2b is a state diagram illustrating detection of a static state of a camera view.

FIG. 3 is a flowchart of a method according to one embodiment.

### PREFERRED EMBODIMENTS

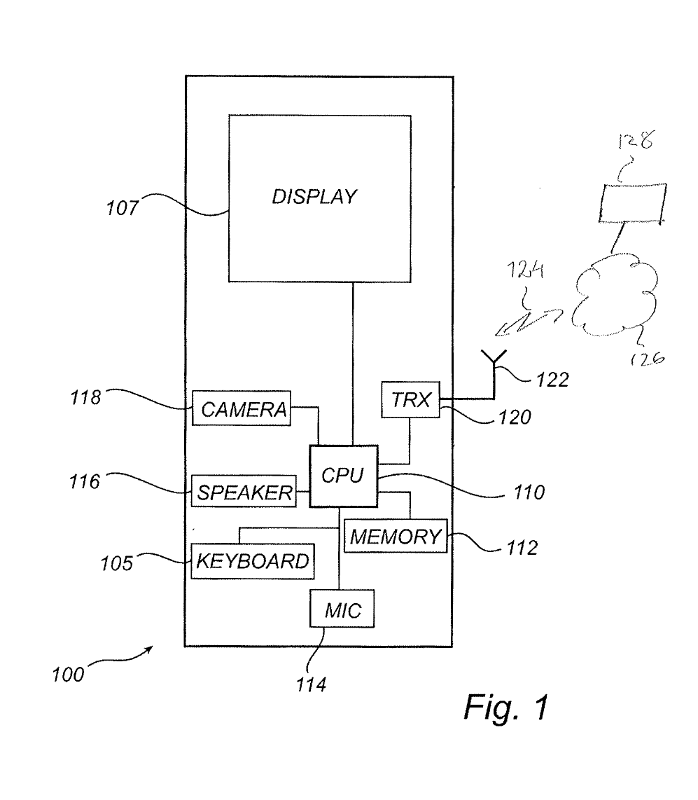

FIG. 1 shows a block diagram of a mobile communication terminal in the form of a telephone 100 according to the present invention. The terminal 100 comprises a processing unit 110 connected to an antenna 122 via a transceiver 120, a memory unit 112, a microphone 114, a keyboard 105, a speaker 116 and a camera 118. The processing unit 110 is also connected to a display 107.

No detailed description will be presented regarding the specific functions of the different blocks of the telephone 100. In short, however, as the person skilled in the art will realize, the processing unit 110 controls the overall function of the functional blocks in that it is capable of receiving input from the keyboard 105, audio information via the microphone 114, images via the camera 118 and receive suitably encoded and modulated data via the antenna 122 and transceiver 120. The processing unit 110 is also capable of providing output in the form of sound via the speaker 116, images via the display 107 and suitably encoded and modulated data via the transceiver 120 and antenna 122.

The terminal 100 is typically in connection with a communication network 126 via a radio interface 124. As the skilled person will realize, the network 126 illustrated in FIG. 1 may represent any one or more interconnected networks, including mobile, fixed and data communication networks such as the Internet. A “generic” communication entity 128 is shown as being connected to the network 126. This is to illustrate that the terminal 100 may be communicating with any entity, including other terminals and data servers that are connected to the network 126.

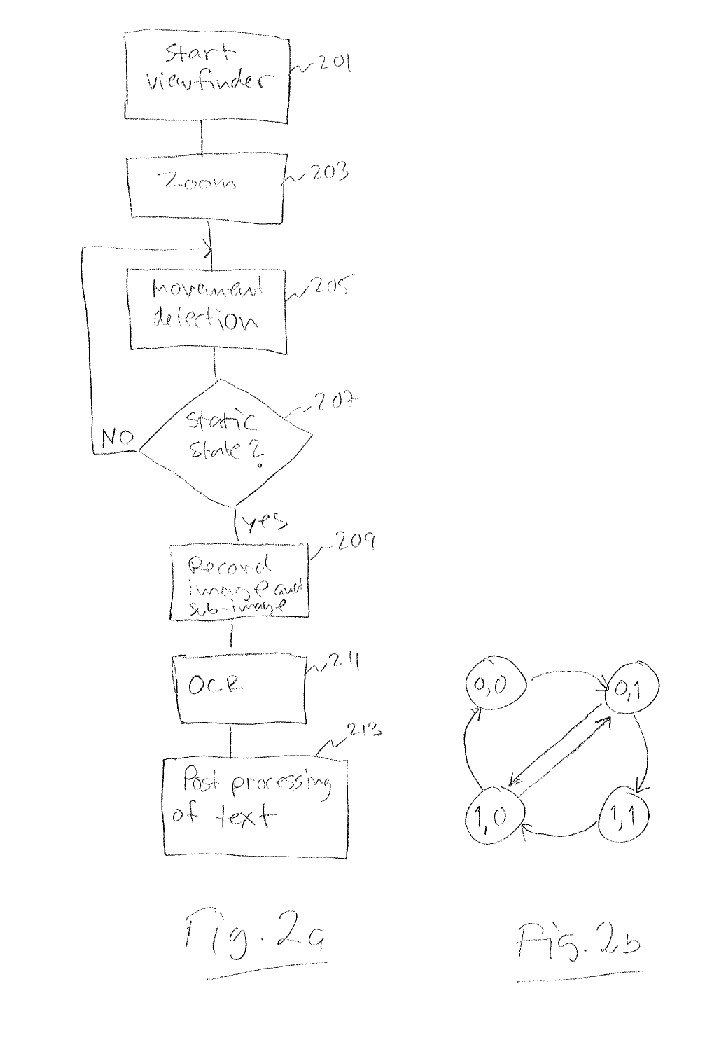

A method according to the invention will now be described with reference to a flow chart in FIG. 2a and a state diagram in FIG. 2b. The method is preferably implemented as software steps stored in a memory and executed in a CPU, e.g. the memory 112 and CPU 110 of the terminal 100 in FIG. 1.

In a viewfinder mode, started during a viewfinder start step 201, image sampling rate is performed at typically 15 frames per second with a typical frame size of 160×120 pixels and the sampling rate is typically about 60 micro seconds per frame. Since 60 micro seconds is much shorter than the typical reaction time of a normal human user, the sampling rate is down-sampled to one frame out of every five frames. The display frequency is thereby 15 frames per second, which to a human user looks essentially continuous. During this step, a user aims the camera such that a text is viewed in the viewfinder, i.e. typically on the terminal display. Detection of the movement of the view in the viewfinder is performed, not at every frame, but typically once every 300 micro seconds in order to save computational power and smoothen out noise. During the viewfinder mode, a guiding pattern is displayed, typically at the center of the view in the viewfinder, for aiding the user when aiming at the target.

Zooming of the camera is then performed in a zoom step 203. The camera settings are set by adjustment of the automatic digital zoom parameters. The purpose of the automatic digital zoom is to obtain a suitable target size in the viewfinder frame. For a camera terminal that has both digital zoom and optical zoom functionalities, it is difficult for a user to cross-adjust the zoom parameters to obtain a good quality image for OCR. Hence, intelligent digital zoom parameter estimation is used, which limits the capture distance within a small range and ensures the proper size of target in the viewfinder. The end user only need to trigger the optical zoom to make the imaging clear.

Movement detection 205 of the camera is realized by using any qualified moving tracking/detection algorithms known in the art. For simplicity, only the area close to the position at which the guiding pattern is displayed in the viewfinder is detected. The movement detection algorithm is preferably tolerant to the small hand shaking that is inevitable for many human users. Thus, a hand-held shaking model is introduced to avoid false detection due to such hand shaking. The hand-held shaking model is typically one that has been established beforehand, for example by the collecting of two classes of samples: hand-held shaking movements and real movements during a search stage (i.e. during scanning movement across potential target texts). Statistical classification of the two classes can be built into the learning stage, thereby enabling the use of a fast decision tree during the operation of the invention.

Whether the view is in a static state or not, is decided in a decision step 207, which is implemented using a state machine as illustrated by a state transition diagram in FIG. 2b. The state pairs (previous, current) are such that 0 means a moving state and 1 means a static state. That is, a state (previous, current)=(0,0) is a state where the view continues to be in a moving state after being detected as moving, a state (previous, current)=(1,1) is a state where the view continues to be in a static state after being detected as static, a state (previous, current)=(1,0) is a state where the view is detected as being moving after having been detected as being static, and a state (previous, current)=(0,1) is a state where the view is detected as being static after having been detected as being moving.

The continued processing will start when entering state (0,1), that is the situation where the camera has been moved and then been focused on the target for a relatively long time period, e.g. several hundred micro seconds. If the camera is keeps unmoved for a longer time, no iterative starting of processing will be caused until the camera moves again and stops on another target. The state-based decision effectively avoids unnecessary processing (normally OCR is sensitive to the small change of input image if the character size is close to the limitation of the lower bound, so overlapped recognizing of the similar images might cause unstable results that will confuse the user) and make the dynamic recognition and any subsequent translation stable.

When state (previous, current)=(0,1) has been determined in the determination step 207, processing of automatic object extraction is started in a record step 209. Here, extraction is made of the target text to be translated from the recorded image. Because the position of the guiding pattern has already provided prior knowledge about the position of the target, a connect-component-based algorithm is applied for object detection and segmentation. If the target is an isolated word, layout analysis gives the accurate block of the word, otherwise a relative region (e.g. a line of Chinese characters without splits) will be extracted.

The extracted target text is then provided to an OCR process in step 211. The OCR processing involves a number of different procedures and considerations. For example, in Chinese-to-English translation, there is often a problem to identify which combination of characters could compose a valid unit (word/phrase) to be translated. Therefore, if there is no layout information available, linguistic analysis should be used after OCR. Rule based word association may be used to find out the possible combination of the concurrent characters by using context sensing and linguistic rules. The valid combination whose position is nearest to the guiding pattern is typically selected as the intended target text.

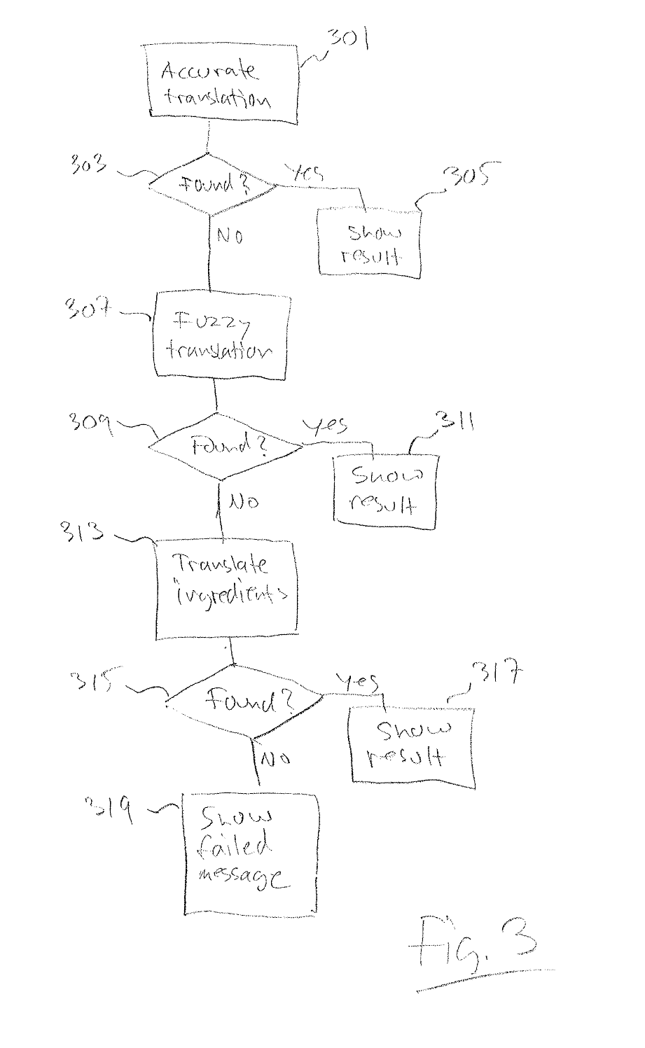

The recognized text may then be provided to a post processing procedure 213, which will be exemplified with reference to a flow chart in FIG. 3. The example of the post processing is one in which a restaurant menu item written in a first language is interpreted into a second language, for example a Chinese menu comprising menu items written in Chinese that is to be translated into English. Two databases are used, a dish menu database and an ingredient database and the translation is performed using a three step translation procedure including an accurate translation step, a fuzzy translation step and an ingredient translation step. The databases are typically realized in memory means arranged in the terminal, but may also be realized in other entities connected to a network with which the terminal communicates.

The dish menu database is the main database consisting of Chinese and English names of dishes. The database is used to look up a Chinese dish name and retrieve the exact English translation. The ingredient database includes some key ingredients involved in dishes such as chicken, beef, fish etc. The database is used to check the ingredient(s) in a dish. Based on the information in the database, even if the interpretation fails to provide a correct dish name during the fuzzy translation, it still can give users a hint of the ingredient(s) of the dish that is of interest. For example, supposing a dish name, say “sauteed potato and steak” (in Chinese), can not be found in the dish menu database by any of the accurate and fuzzy translation, it will be compared with the ingredients in the ingredient database automatically. In the ingredient database, the words of potato and steak can be found and the user will be informed that this dish may include some potatoes and steak.

Hence, with reference to FIG. 3, the three categories of translating include accurate translating in a first translation step 301, fuzzy translating in a second translation step 307 and ingredient translating in a third translation step 313. Accurate translating means that the words to be translated should be exactly the same as the words in the dish menu database. Fuzzy translating means that the words are similar to the words in the dish menu database, but not exactly the same. Ingredient translating means that the words are searched in the ingredient database, word by word, to check which kinds of ingredient are in the dish. The three categories of translating are performed in a priority order. The accurate translation is performed initially, the result checked in a first decision step 303 and if no result is been found, the fuzzy translation will be done. At last, after a second decision step 309, if still no result has been found, the word by word ingredient translation is performed in the final operation. If any of the decision steps 303, 309 and 315 finds that a successful translation has been performed, then a respective step 305, 311 and 317 of displaying the result is performed. In the event of finding, in the third decision step 315, that no translation is found, a failure message is displayed in a display step 319.

A key issue in the fuzzy translation is the question of how to judge the fuzzy words. Here is introduced a distance function that is used to calculate the distance between query words and records in the database. Mainly, such a function calculates two parts, i.e. the difference of words length and the number of matched characters. Because similar words should have nearly the same length, the difference of the words length is the most important factor and given a weight of w₁, which may be set three times as large as a weight of number of matched characters w₂. Thus, the expression for the distance, Dist, is as follows.

### Supposing:

w₁=3*w₂
L₁=Length of the first words.
L₂=Length of the second words.
Matched=Number of matched characters.
   then:

$$Dist = \frac{{w}_{1} * \vert {L}_{1} - {L}_{2} \vert}{Max ( {L}_{1} , {L}_{2} )} + \frac{{w}_{2} * {( {L}_{2} - Matched )}^{2}}{{L}_{2}}$$

Given a value for w₁ of 300 and a value for w₂ of 100, a threshold of 80 can be used to judge whether the two words are similar. If the distance is greater than 80, the two words are not similar. If the distance is 0, the two words are exactly the same. Hence, if all the distances between the word to be translated and the words in the dish menu database are greater than 80, ingredients translating is used. If there is a distance of 0 between one word in the database and the word to be translated, the accurate translation is used. Otherwise, the fuzzy translating mode is chosen.

Even though the above example uses translation of restaurant menu items, the invention is of course applicable in many other fields.

That is, the invention can be applied on any relevant target text, including street signs, restaurant name signs, etc. The non-click, concept useful, not least due to it's simplicity from a user perspective, for automatic extraction of text from an image.

Examples of fields of use include translation of medicine terms, company name and company address translation. For example, main ingredients of medicines can be listed for understanding a kind of medicine in case of emergency and a database of the main districts and streets of a city can be constructed and used for locating a company.

Another good use case is for performing product/commodity search in a store such as a supermarket. Users can scan the brand/logo/specification of any goods and a specific data search/translation can be performed as described above.

Furthermore, a normal dictionary can be used for translation of the recognized text. The multi-level translation model then operates with a common dictionary for word translation from a first language to a second language. In fact, the invention should not only be considered as useful in connection with translation, it may be seen as a kind of “component-based search” method, for which the input method could be OCR-based as the examples described above. The component-based matching method can be used for any specific database search; if accurate matching is not available, the fuzzy match and keyword/ingredient search will be used.

1. A method of controlling a mobile communication terminal, while the terminal is in an image recording mode during which a camera view is displayed, the method comprising:
displaying a guiding pattern configured such that it facilitates for a user to adjust the camera view,
detecting that the camera view is in a static state,
recording an image of the camera view in the detected static state,
extracting a sub-image comprising an array of picture elements from the recorded image, said sub-image being at a position within the recorded image that corresponds with the guiding pattern being displayed,
performing an optical character recognition process on the extracted sub-image, yielding a sequence of symbols,
displaying the recognized sequence of symbols.

2. The method of claim 1, where the detection that the camera view is in a static state comprises detection of spatial changes and detection of absence of spatial changes in the camera view during a specific time interval.

3. The method of claim 1, where the detection that the camera view is in a static state comprises processing of an algorithm representing a hand-held shaking model.

4. The method of claim 3, where, prior to the recording an image of the camera view in the detected static state, the hand-held shaking model is determined by way of a training sequence involving detections of spatial changes and detection of absences of spatial changes in the camera view during specific time intervals.

5. The method of claim 1, further comprising, prior to the recording of an image of the camera view:
zooming the camera view such that the extraction of the sub-image results in an extracted sub-image having a predetermined spatial scale.

6. The method of claim 1, where the image recording mode is such that, during the displaying of the camera view, a first spatial image scale is used and, during the recording of an image of the camera view in the detected static state, a second spatial image scale is used.

7. The method of claim 1, further comprising:
processing the recognized sequence of symbols, said processing involving a translation process comprising accessing at least a first data base of words.

8. The method of claim 7, where the translation process includes at least one step of a three-step procedure of accurate translation, fuzzy translation and word-by-word translation.

9. The method of claim 8, where a first database comprises words representing compound items and a second database comprises words representing ingredients of compound items in the first database.

10. The method of claim 9, where the translation process involves translation of restaurant menu words.

11. A mobile communication terminal comprising control means and a camera that are configured such that they are capable of, in an image recording mode during which a camera view is displayed:
displaying a guiding pattern configured such that it facilitates for a user to adjust the camera view,
detecting that the camera view is in a static state,
recording an image of the camera view in the detected static state,
extracting a sub-image comprising an array of picture elements from the recorded image, said sub-image being at a position within the recorded image that corresponds with the guiding pattern being displayed,
performing an optical character recognition process on the extracted sub-image, yielding a sequence of symbols,
displaying the recognized sequence of symbols.

12. A computer program comprising software instructions that, when executed, performs the method of claim 1.
